(19) United States
(12) Patent Application Publication
(10) Pub. No.: US 2019/0149540 A1
(43) Pub. Date: May 16, 2019

(54) SERVICE PROVISION SYSTEM, SERVICE PROVISION METHOD, VERIFICATION DEVICE, VERIFICATION METHOD, AND COMPUTER PROGRAM

(71) Applicant: Caulis lnc., Tokyo (JP)

(72) Inventor: Atsuyoshi Shimazu, Tokyo (JP)

(73) Assignee: Caulis lnc., Tokyo (JP)

(21) Appl. No.: 16/098,612

(22) PCT Filed: Mar. 30, 2017
(86) PCT No.: PCT/JP2017/013192

§ 371 Date: Nov. 2, 2018

(30) Foreign Application Priority Data
May 3, 2016 (JP) 2016-092850

(51) Int. Cl. H04L 29/06; H04L 12/24; H04W 12/08; H04W 12/06; H04W 12/00

(52) U.S. Cl. CPC H04L 63/0853; H04L 63/101; H04L 41/5054; H04W 12/0051; H04L 63/105; H04W 12/0804; H04W 12/06; H04L 63/102

(57) ABSTRACT

A service provision system provides a predetermined service to a user and includes a server unit configured to provide a service and an authentication server unit configured to determine whether the user is an authorized user, wherein the server unit includes a service provision means that provides information about the user to the authentication server unit and executes provision of the service to the user who is determined as an authorized user and a transmission means that transmits information about an operation performed by the user on the server unit to a verification device, wherein the authentication server unit includes a determination means that determines whether the user is an authorized user based on information about the user and a reception means that receives an index indicating that the user is not an authorized user from the verification device.

### TECHNICAL FIELD

This disclosure relates to a service provision system and provision method that provide a predetermined service to a user, and also relates to a verification device and verification method that are used for the service provision system to authenticate a user and, additionally, relates to a computer program related to these devices.

### BACKGROUND

Websites (service provision systems) that provide various services for users via a network such as the Internet are known.

A user who desires to use such a website can access and log into the website using a given ID and password and can receive a desired service using the website. For example, a user who uses an online shopping website may log into the website using an ID and a password, move through pages that the website provides, and can purchase a product on a page on which a desired product is found.

In websites of the related art, an ID and a password are often used so that only an authorized user can use a website. It is thought that, when this ID and password are used, it is possible to exclude so-called malicious intruders, and services can be used smoothly.

However, in recent years, cases in which a malicious third party has obtained an ID and a password of another person using an unauthorized means have been reported. When a malicious third party logs into a website using an ID and a password of another person (who is an authorized user) in this manner, it is difficult to distinguish whether the user logging in is an authorized user or a malicious third party according to only the ID and password.

Therefore, in recent years, a mechanism in which information about operations after login executed by an authorized user is recorded and stored in a database as a whitelist has been introduced. For example, information about operations to be recorded is preferably the following information:

### OS

### Browser

### Language

IP address (represents a geographical location at which a user who performs access is located)
Time (access time).

When these information items are recorded and used to construct a database as a so-called whitelist, it is possible to detect when a user who is logged in performs an unusual operation. In this manner, it is preferable to perform additional authentication to confirm that a user performing an unusual operation is not a malicious third party. For example, the message “The following website is currently being accessed using your ID. Was this access performed by you? If not, please press (touch) the NO button,” may be sent to a mobile phone, a smart phone or the like that a user is holding, and when the “NO button” is pressed (touched), it is possible to determine that access has been performed by a malicious third party who is not the authorized user. Then, it is possible to perform a process of disconnecting access for the user immediately.

For example, a case in which access is performed in an unusual place (IP address) and a case in which access is performed on an unusual computer (OS, browser) may be exemplified. In such cases, additional authentication is performed and it is confirmed whether access is being performed by an authorized user (also called identification confirmation).

In addition, in many cases, the whitelist is constructed based on about several tens of previous accesses performed by the authorized user, but it may be constructed based on a smaller number of accesses (several times), or a larger number of accesses (several hundreds of times). In addition, the whitelist may be replaced and updated with new information whenever an authorized user performs access.

For example, in Japanese Unexamined Patent Application, First Publication No. 2012-159939, a device that searches for content information using a whitelist and a blacklist is disclosed. That publication discloses that when both lists are used, privacy is protected.

In addition, for example, in Japanese Unexamined Patent Application, First Publication No. 2011-3132, an access control system that controls access to a website using a whitelist and a blacklist is disclosed.

In this manner, information about an access operation performed by an authorized user is recorded as a whitelist, and additional authentication is appropriately performed for a user who performs an operation significantly different from one on the whitelist.

However, malicious third parties are good at pretending to be authorized users themselves, and thus it is generally difficult to find them. Therefore, in many cases, security officers deal with this problem according to empirical rules. For example, according to an empirical rule that withdrawal of a full withdrawal limit from a savings account on a financial institution website is highly likely to have been performed by a malicious third party, a malicious third party may be determined here.

Furthermore, regarding IDs and passwords, common IDs and passwords may be used for a plurality of websites in many cases. In this case, when a malicious third party illegally acquires a set of an ID and a password, unauthorized access may be consecutively performed for a plurality of websites in many cases.

In such a case, when unauthorized access to one website is detected, information about this detection is provided to an operator of another website. This is thought to be effective in preventing consecutive unauthorized access using the above-described common ID and password.

However, such a mechanism has not yet been sufficiently realized. A rule for determining, for example, which information is valid as information about such unauthorized access has not been constructed. In addition, it is hard to say that a certification method for an unauthorized access is sufficiently established in the world. In addition, for example, even if a certain IP address is used for unauthorized access, the IP address may not always be used for unauthorized access.

It could therefore be helpful to provide a system in which information that may relate to unauthorized access is stored in a database as a blacklist and it is possible to efficiently detect similar unauthorized access. In addition, it could be helpful to provide a device, a method, and a computer program to realize the system.

### SUMMARY

We thus provide:

(1) A service provision system provides a predetermined service to a user, including:

a server unit configured to provide a predetermined service to the user; and

an authentication server unit configured to determine whether the user is an authorized user,

wherein the server unit includes

a service provision means that provides information about the user to the authentication server unit and executes provision of the predetermined service to the user who is determined as an authorized user by the authentication server unit, and

a transmission means that transmits information about an operation performed by the user on the server unit to an external verification device,

wherein the authentication server unit includes

a determination means that receives information about the user from the server unit and determines whether the user is an authorized user, and

a reception means that receives an index indicating that the user is not an authorized user from the external verification device, and

is able to acquire the index that the user is not an authorized user.

(2) The service provision system according to (1), wherein the authentication server unit further includes a confirmation instruction means that, when it is determined that a probability of the user not being an authorized user is a predetermined threshold value or more based on the index received by the reception means, issues an instruction to execute a confirmation process of confirming whether the user is an authorized user to the server unit, and

wherein, when the instruction to execute the confirmation process is received, the service provision means of the server unit executes the confirmation process for the user.

(3) The service provision system according to (1) or (2), wherein, when a result of the confirmation process performed by the service provision means is that it is determined that the user is not an authorized user, the transmission means transmits information indicating that the user is not an authorized user to the external verification device.
(4) A verification device configured to obtain, based on information about an operation performed by a user, an index indicating that the user is not an authorized user, including:

a communication means that receives information about an operation performed by a user from an external service provision system;

a blacklist database in which information about an operation performed by a user who is determined as not being an authorized user is recorded; and

a blacklist index calculating means that compares information about an operation performed by the user received by a reception means with data in the blacklist database, and calculates an index indicating that the user is not an authorized user from its degree of similarity and transmits the index.

(5) The verification device according to (4), wherein the communication means transmits the index indicating that the user is not an authorized user to the outside.
(6) The verification device according to (4) or (5), wherein the index indicating that the user is not authorized is a probability of the user not being an authorized user.
(7) The verification device according to any one of (4) to (6), wherein, in a whitelist database in which information about an operation performed by the authorized user is recorded,

when it is determined that the information about an operation performed by the user received by the reception means does not correspond to a record in the whitelist database, in the blacklist database, the information about an operation performed by the user received is registered in the blacklist database.

(8) The verification device according to any one of (4) to (7), wherein, when the reception means has received the information indicating that the user is not an authorized user, in the blacklist database, a black confirmation flag is set for information about an operation performed by the user in the blacklist database.
(9) The verification device according to (8), wherein the blacklist index calculating means compares the information about an operation performed by the user received by the reception means with a record in the blacklist, and when the black confirmation flag of a record in the blacklist having a high degree of similarity is set, calculates an index indicating that the user is not an authorized user to be higher and transmits the index.
(10) A service provision method of providing a predetermined service to a user using a service provision system that includes a server unit configured to provide a predetermined service to the user and an authentication server unit configured to determine whether the user is an authorized user, the method including:

a service provision step in which the server unit provides information about the user to the authentication server unit, and when the authentication server unit determines that the user is an authorized user, provision of the predetermined service to the user is executed;

a transmission step in which the server unit transmits information about an operation performed by the user on the server unit to an external verification device;

a determination step in which the authentication server unit receives information about the user from the server unit and it is determined whether the user is an authorized user; and

a reception step in which the authentication server unit receives an index indicating that the user is not an authorized user from the external verification device.

(11) A verification method of obtaining, based on information about an operation performed by a user, an index indicating that the user is not an authorized user, including:

a communication step in which information about an operation performed by the user is received;

a step in which information about an operation performed by the user who is determined as not being an authorized user is recorded in a blacklist database; and

a blacklist index calculation step in which information about an operation performed by the user received in the communication step is compared with data in the blacklist database, and an index indicating that the user is not an authorized user is calculated from its degree of similarity and transmitted.

(12) A computer program causing a computer to operate as a service provision system that includes a server unit configured to provide a predetermined service to a user and an authentication server unit configured to determine whether the user is an authorized user, the computer program causing the computer to execute:

a service provision procedure in which the server unit provides information about the user to the authentication server unit, and when the authentication server unit determines that the user is an authorized user, provision of the predetermined service to the user is executed;

a transmission procedure in which the server unit transmits information about an operation performed by the user on the server unit to an external verification device;

a determination procedure in which the authentication server unit receives information about the user from the server unit and it is determined whether the user is an authorized user; and

a reception procedure in which the authentication server unit receives an index indicating that the user is not an authorized user from the external verification device.

(13) A computer program causing a computer to operate as a verification device configured to obtain, based on information about an operation performed by a user, an index indicating that the user is not an authorized user, the computer program causing the computer to execute:

a communication procedure in which information about an operation performed by the user is received;

a procedure in which information about an operation performed by the user who is determined as not being an authorized user is recorded in a blacklist database; and

a blacklist index calculation procedure in which information about an operation performed by the user received in the communication procedure is compared with data in the blacklist database, and an index indicating that the user is not an authorized user is calculated from its degree of similarity and transmitted.

In this manner, since a blacklist database is constructed, and an index indicating that the user is not an authorized user is provided based on the blacklist database, it is possible to detect access by a user who is determined as not being an authorized user more efficiently.

### BRIEF DESCRIPTION OF THE DRAWINGS

FIG. 1 is an explanatory diagram illustrating an overview of a configuration of a Website 10 according to an example.

FIG. 2 is an explanatory diagram showing an example of a record of a whitelist database and an example of a record of a blacklist database.

FIG. 3 is an overall configuration diagram showing a flow of processes in which the Website 10 in the example provides a service.

FIG. 4 is a configuration block diagram of a verification server 34.

FIG. 5 is a time chart showing a flow of operations of the entire system according to the example.

FIG. 6 is a flowchart showing operations of the verification server 34.

FIG. 7 is a flowchart showing operations of the verification server 34.

### REFERENCE SIGNS LIST

10 Website
12 Top page
14 Login page
16 Product page
18 Company profile page
20 Member information page
22 Purchase page
24 Money transfer and points exchange page
30 User
32 Operator system
32a Web server
32b Authentication server
Verification server
34a Communication means
34b Whitelist database
34c Blacklist database
34d Probability calculating means
40 Transmission of browser information
42 Transmission of browser information
44 Transmission of ID and password
46 Transmission of hashed ID and password
48 Transmission of pretending probability
50 Transmission of login permission
52 Transmission of page movement
54 Transmission of page transition information
56 Transmission of pretending probability
58 Additional authentication
60 Unauthorized confirmation
62 Unauthorized confirmation
64 Forced log off
BLDB Blacklist database
WLDB Whitelist database

### DETAILED DESCRIPTION

A preferred example will be described below with reference to the drawings.

### 1. Basic Idea

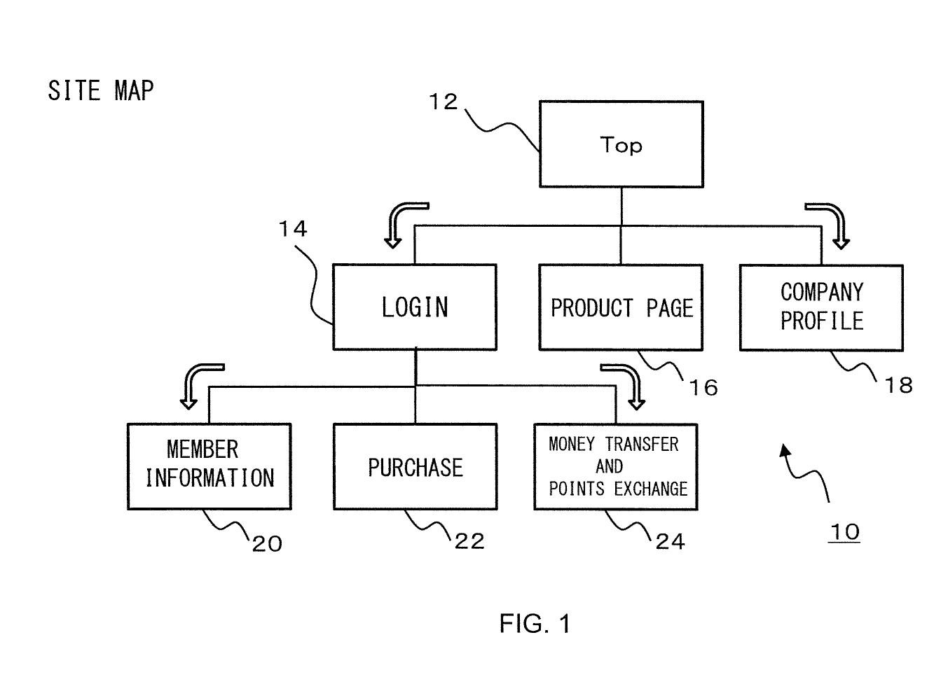

FIG. 1 is an explanatory diagram illustrating an overview of a configuration of a website that provides a predetermined service (for example, a shopping mall) via a network such as the Internet. FIG. 1 is one type of diagram called a so-called site map.

A website 10 shown in FIG. 1 will be described below as one that constitutes, for example, a shopping mall. First, the website 10 includes a Top page 12, and the Top page is linked to a login page 14, a product page 16, and a company profile page 18, and a user can move between pages. In the login page 14, a user logs in using an ID and a password, and then can move to a member information page 20, a purchase page 22, and a money transfer and a points exchange page 24.

In such a website 10, the user performs, for example, the following operations.

### (1) User Operation, Whitelist and Blacklist

A user who wishes to use a shopping mall first accesses the Top page 12, and then moves to the product page 16, and browses through products that the user may wish to purchase. A user who has decided a product that he or she wishes to purchase moves to the login page 14 and inputs an ID and a password, and logs in. Then, the user moves to the purchase page 22, and performs a product purchase procedure. The user purchases the product, and then moves to the money transfer and points exchange page 24, checks the points which have been accumulated previously and products that can be exchanged for the points, logs off, and ends use of the website 10.

When the user performs such an operation, the website 10 records the operation performed by the user and constructs a whitelist database. Examples of operations performed by the user to be recorded include not only a page transition (movement between pages), but also an IP address of a user that can be acquired from a browser that the user uses, a type of a terminal that is being used, and an OS that is being used. When these operations are recorded and a whitelist database is constructed, it is possible to create a database for a “user likeness.”

According to such a whitelist database, it is possible to compare the operations performed by the user and operations performed by the user before for verification, and it is possible to ascertain whether the user is performing an operation which is the same as one before or is performing an operation that he or she has not performed before.

Then, in a page transition and the like within the website 10 performed by the user, when an operation different from that performed by the user before is detected, it is possible to register it in a so-called blacklist database instead of the whitelist database based on the detection. The blacklist database is a database in which information about an operation that may be performed by an unauthorized user is recorded. As a result, it is possible to take a measure such as performing additional authentication (risk-based authentication) on the user. It is possible to block access performed by a malicious third party that pretends to be the user in some cases.

In this case, the malicious third party may be a human performing access using a keyboard or the like or may be a computer or the like that mechanically pretends to be the user and performs access.

### (2) Blacklist

A feature of this example is that operations different from those in the whitelist database are stored in a database as a blacklist database in addition to construction of authorized user likeness as a whitelist database. When a database is constructed in this manner, it is possible to store, accumulate and compare information about an unauthorized “pretending” operation, and detect unauthorized access such as pretending by a malicious third party more efficiently, and further improve a likelihood of exclusion.

“Different” basically means that an operation includes data that is not similar to a record registered in the existing whitelist database. In addition, examples regarded as “different” may include not only examples in which data is not similar but also examples in which access from a specific IP address has been performed 100 times or more in a day.

### (3) Content of Whitelist and Blacklist

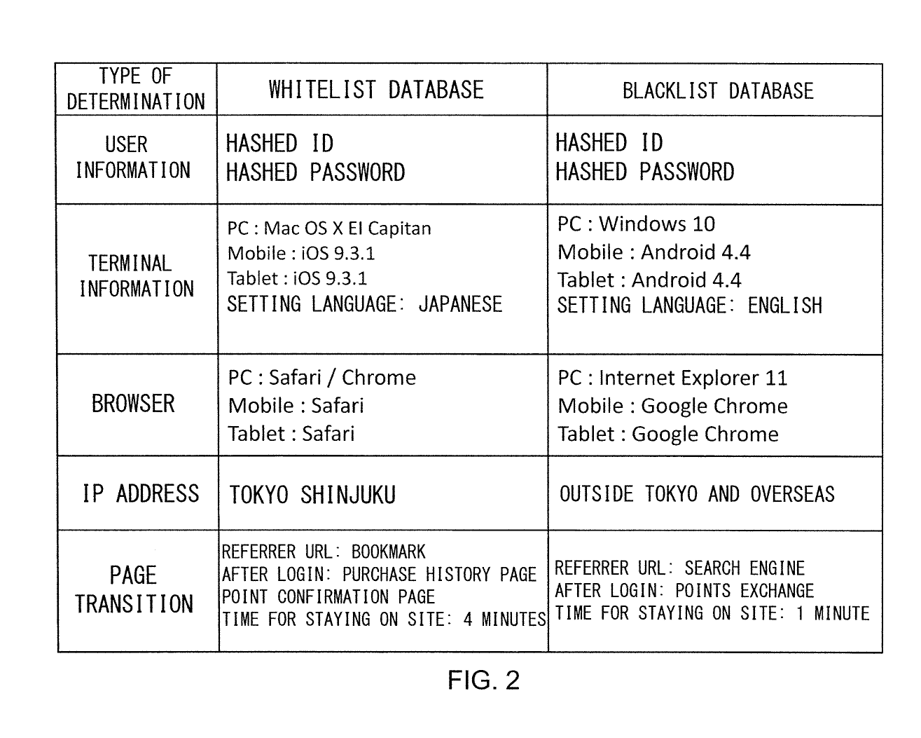

The content of the whitelist database and the blacklist database constructed in this example will be exemplified. The content recorded in both is almost the same. However, in the blacklist database, as will be described below, a black confirmation flag that is not provided in the whitelist database is provided for each record. In FIG. 2 described next, the black confirmation flag is omitted and is not shown. An operation and function of the black confirmation flag will be described below in detail.

FIG. 2 is an explanatory diagram showing an example of a record of a whitelist database in which information about operations performed by an authorized user is recorded and an example of a record of a blacklist database in which information about operations performed by a malicious third party that pretends to be the authorized user is recorded.

As shown in FIG. 2, content recorded in the whitelist database (and the blacklist database) is divided into five types. First type information is user information and mainly includes an ID and a password. The user information is information that identifies a user 30 who is performing an operation.

The user information is recorded in both the whitelist database and the blacklist database, and both a hashed ID and a hashed password are recorded therein. This is performed to make an amount of data compact and a comparison operation and the like easier, and to prevent a person from being completely identified, and reduce a likelihood of leakage of personal information.

Second type information is terminal information and is information about a terminal used for a user to access the website 10, and a type of a terminal used, a type of an OS and the like are recorded. In addition, information about a language used is recorded. Third type information is information about a browser that a user uses. This browser information is recorded for each terminal used. Even if there are a plurality of types of browsers used, information about a plurality of browsers is recorded.

Fourth type information is an IP address of a user. It is possible to identify a location of the user from the IP address. Fifth type information is a page transition. As shown in FIG. 2, this information is information indicating a referrer URL or which page was viewed on the website 10. For example, in FIG. 2, after an authorized user of the whitelist database logs in, the user confirms a purchase history in a purchase history page, and then browses a point confirmation page and confirms an available point. A malicious third party who pretends to be an authorized user in the blacklist database logs in, and then immediately moves to a points exchange page and tries to exchange points. In this manner, it is empirically known that the pages viewed on the website 10 is greatly different for a malicious third party who pretends to be an authorized user.

In addition, in the page transition information, a time of staying on the website 10 is recorded. Generally, it is known that a time for which a malicious third party stays on the website 10 is shorter than that of an authorized user. As such time information, additionally, a time of staying on each page that has been viewed is preferably recorded.

The malicious third party may be a human or a machine (computer) that pretends to be an authorized user. When such a computer pretends to be an authorized user, a time of staying on the whole website 10 and a time of staying on each page are very short in many cases, and it is possible to distinguish a malicious third party from a human based on these staying times. In addition, it is possible to distinguish the malicious third party from a human based on an unusually rapid text input speed.

In the example shown in FIG. 2, to facilitate understanding, an example in which operations of an authorized user and a malicious third party are greatly different in terminal information, browser information and the like is shown. However, an example in which any one type of information is greatly different from that of the whitelist database may be determined as “different.” For such determination criteria, various criteria may be used. In this manner, when an operation performed by a user (a third party that pretends to be a user) who has accessed the website 10 is compared with information about an operation registered in the whitelist database, and it is determined as “different” from data registered in the whitelist database, the information about the operation is registered in the blacklist database.

When the blacklist database is constructed, if information about an operation performed by the user 30 is compared with information in the blacklist database and is similar thereto, it is possible to efficiently determine that the user has a high probability of being a malicious third party pretending to be the user.

The content recorded described here is an example, and various additional types of information may be recorded. In addition, the content recorded described here is a typical example, and a whitelist database and a blacklist database may be constructed using fewer types of information.

### 2. Specific Configuration of the Example

### (1) Overall Configuration of System in the Example

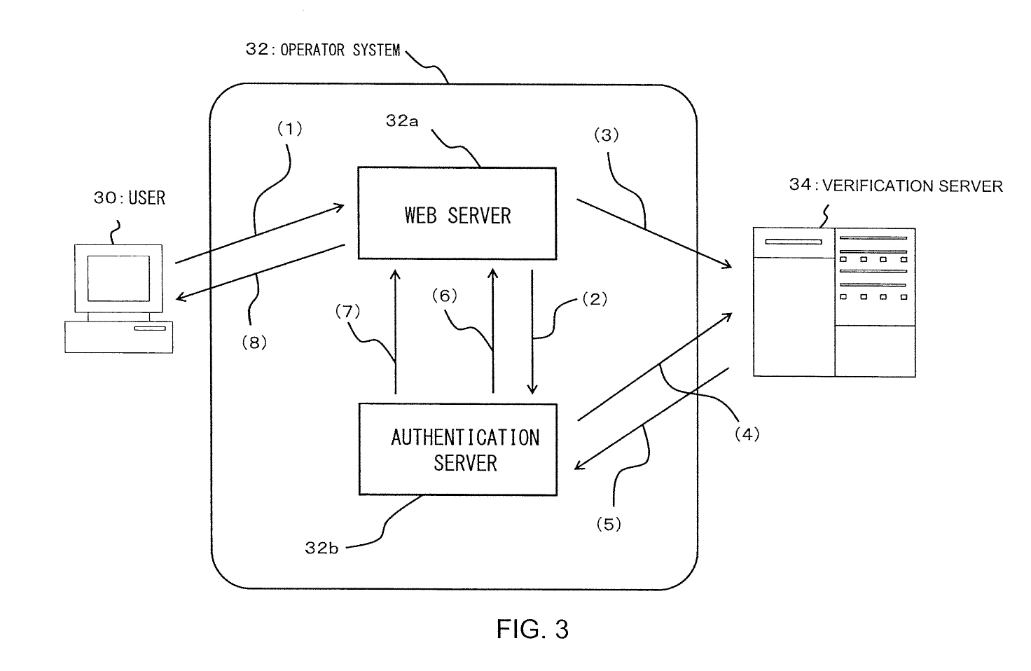

FIG. 3 is an overall configuration diagram showing a flow of processes in which the website 10 in this example provides a service. As shown in FIG. 3, this service is provided through components including the user 30, an operator system 32, and a verification server 34. These components are connected to each other via a communication network such as the Internet and can mutually (or unidirectionally) transmit and receive information, instructions, messages, a pretending probability to be described below and the like.

### (2) User

The user 30 is a user 30 who accesses the website 10 (for example, a shopping mall), and accesses the website 10 from a computer or a mobile terminal. A computer or a mobile terminal that the user 30 uses is called a “user” 30 for convenience of explanation.

When the user 30 accesses the website 10, he or she tries to log in using an ID and a password on a login page. This operation is shown in (1) in FIG. 3.

(3) Operator system

The operator system 32 is a system that realizes the website 10 and is, for example, a system for an operator who operates a shopping mall. The operator system 32 includes a Web server 32a and an authentication server 32b.

The operator system 32 corresponds to a preferable example of a service provision system in the scope of claims.

### (3-1) Web Server

The Web server 32a is a Web server that provides the website 10. The operation of the website 10 is described using, for example, Hypertext Markup Language (HTML). The Web server 32a corresponds to a preferable example of a server unit in the scope of claims.

The Web server 32a in this example has roughly two types of functions (means). Each function is realized by a program that describes such a function and a CPU (or a processor) of the Web server 32a that executes the program.

### Service Provision Function

First, the Web server 32a has a service provision function for providing a service of a website to the user 30. This function is a function of providing a general website, and is realized when a CPU or the like of the Web server 32a executes a Web server program. A specific configuration and function of the website 10 may be described using, for example, HTML. In addition, the service provision function also includes a function of transmitting an ID and password input by the user 30 to the authentication server 32b (shown in (2) in FIG. 3).

In addition, when a process of additional authentication is performed on the user 30, the service provision function instructs a transmission function to be described next to transmit the result.

The service provision function corresponds to a preferable example of a service provision means in the scope of claims.

### Transmission Function

In addition, the Web server 32a in this example has a transmission function of transmitting information about an operation performed by the user 30 on the website 10 to the external verification server 34. A transmission operation according to this transmission function is shown in (3) in FIG. 3.

The transmission function is preferably realized, for example, by describing a predetermined program in HTML that describes a configuration and function of the website 10. In addition, for example, preferably, JavaScript (registered trademark) that describes a transmission function is embedded in this HTML file and the transmission function is realized.

In addition, when transmission of the result obtained by performing additional authentication is instructed in the service provision function, the additional authentication result is transmitted to the external verification server 34 in the transmission function. In particular, in the service provision function, when it is determined that the user 30 is not an authorized user based on the additional authentication result, information indicating that the user is not an authorized user is transmitted to the verification server 34.

The transmission function corresponds to a preferable example of a transmission means in the scope of the claims.

In this manner, the Web server 32a has a service provision function (service provision means) of providing a service to the user 30 and performing a process related to user authentication, and a transmission function (transmission means) of transmitting predetermined information and messages to the verification server 34.

Therefore, the external verification server 34 can construct a whitelist database and a blacklist database based on the information about an operation performed by the user 30 which is transmitted by the Web server 32a using the transmission function.

### (3-2) Authentication Server

The authentication server 32b performs an authentication operation for the user 30 and determines execution of an authentication operation. The authentication server 32b corresponds to a preferable example of an authentication server unit in the scope of the claims.

The authentication server 32b in this example has roughly three types of functions (means). Each function is realized by a program that describes such a function and a CPU (or a processor) of the authentication server 32b that executes the program.

### Determination Function

First, the authentication server 32b has a function (determination means) of determining whether the user 30 is an authorized user based on the ID and password of the user 30 transmitted from the Web server 32a and returning the determination result (authentication result) to the Web server 32a. This operation is shown in (6) in FIG. 3. The determination function is realized by a program that executes a determination process and a CPU (or a processor) of the authentication server 32b that executes the program. Then, the Web server 32a executes an operation of allowing or rejecting login of the user 30 based on the authentication result of the authentication server 32b.

The determination function corresponds to a preferable example of a determination means in the scope of the claims.

In addition, the determination function of the authentication server 32b includes a function of hashing the ID received from the Web server 32a and transmitting the hashed ID to the external verification server 34. This operation is shown in (4) in FIG. 3. As a result, the verification server 34 can construct a whitelist database in which information about an operation performed by an authorized user is recorded based on the ID and the information about an operation performed by a user provided from the Web server 32a.

### Reception Function

In addition, the authentication server 32b has a function of appropriately receiving a probability that a malicious third party is pretending to be the user 30 (referred to as a “pretending probability”) based on the information about an operation performed by a user from the external verification server 34. This reception operation is shown in (5) in FIG. 3. The reception function is realized by a communication interface for communication with the verification server 34, a program that controls the communication interface, and a CPU (or a processor) of the authentication server 32b that executes the program.

The “pretending probability” is, in short, a probability of the user 30 not being an authorized user, that is, a probability of the user being a malicious third party pretending to be an authorized user or a machine (a computer, a robot, or the like) pretending to be an authorized user.

In this example, a “probability” is used. However, an index indicating a probability can be similarly used. For example, instead of a probability (a real number of 0 to 1), a numerical value of 0 to 255 may indicate a grade for the user 30 not being an authorized user. In addition, an index that expresses a grade for the user 30 not being an authorized user as “high,” “intermediate,” or “low” may be used. In addition, any index can be used as long as it indicates a grade for the user 30 not being an authorized user.

### Confirmation Instruction Function

The authentication server 32b determines whether additional authentication is necessary for the user 30 based on the pretending probability received in the reception function. Then, when it is determined that additional authentication is necessary, the authentication server 32b has a confirmation instruction function of transmitting an additional authentication instruction to the Web server 32a. This additional authentication instruction is shown in (7) in FIG. 3. The confirmation instruction function is realized by a program of comparing a pretending probability with a predetermined threshold value and determining whether additional authentication is necessary, a CPU that executes the program and the like.

In addition, this confirmation instruction function corresponds to a preferable example of a confirmation instruction means in the scope of claims. Furthermore, the additional authentication instruction corresponds to a preferable example of an instruction to execute a confirmation process in the scope of the claims.

When the additional authentication instruction is received, the service provision function of the Web server 32a executes additional authentication for the user 30. Various methods can be used for additional authentication. The message “The website 10 is currently being accessed using your ID, and if this access was not performed by this user, please press (or touch) an invalid button” or the like is transmitted to a mobile terminal for the authorized user 30. On the other hand, if an invalid button is pressed (or touched), it is possible to determine that a user currently accessing the website 10 is a malicious third party pretending to be a user, and access can be disconnected.

### (3-3) Verification Server

The verification server 34 receives and records information about an operation performed by the user 30 transmitted from the Web server 32a and thereby constructs a whitelist database. A feature of this example is that, when information about an operation performed by the user 30 is not similar to the record in the whitelist database (when there is no similar record), it is determined to have a possibility of being a malicious third party pretending to be the user and information about the operation is registered in the blacklist database.

The verification server 34 calculates a probability of the user 30 not being an authorized user based on information about an operation performed by the user 30 ((3) in FIG. 3) transmitted from the Web server 32a using the whitelist database and the blacklist database, and transmits the result to the authentication server 32b (shown in (5) in FIG. 3). The verification server 34 corresponds to a preferable example of a verification device in the scope of claims.

### (3-3a) Configuration of the Verification Server 34

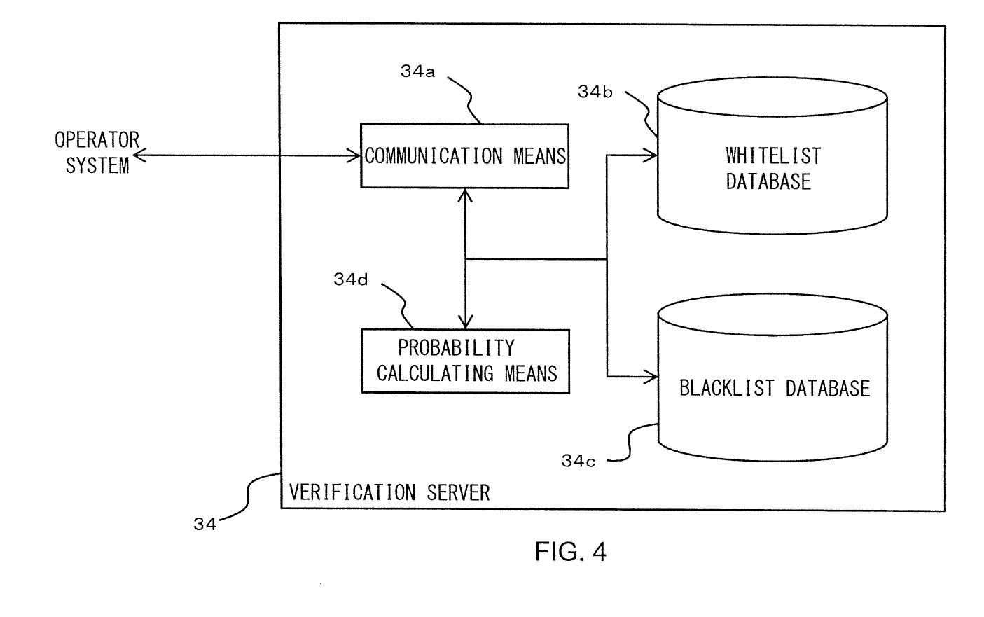

A configuration block diagram of the verification server 34 is shown in FIG. 4. The verification server 34 includes a communication means 34a, a whitelist database 34b, a blacklist database 34c, and a probability calculating means 34d.

### Communication Means

The communication means 34a is a means of transmitting and receiving information and instructions to and from the operator system 32, and receives information about an operation performed by the user 30 transmitted from the Web server 32a as shown in FIG. 3 via a communication network such as the Internet ((3) in FIG. 3), and provides the received information to other means in FIG. 4, the whitelist database 34b, the blacklist database 34c, and the probability calculating means 34d.

The communication means 34a corresponds to a preferable example of a communication means in the scope of claims.

In addition, the communication means 34a transmits the pretending probability calculated by the probability calculating means 34d to the authentication server 32b ((5) in FIG. 3). In addition, the communication means 34a receives the result obtained by performing additional authentication on the user 30 from the authentication server 32b ((4) in FIG. 3).

The communication means 34a includes a communication interface for a communication network and a predetermined communication program that a CPU in the verification server 34 executes. The CPU executes the communication program, and thus controls the communication interface, and realizes the communication means 34a.

### Whitelist Database

The whitelist database 34b is a database in which information about an operation performed by the authorized user 30 is recorded, and is, for example, a database in which information (record) on about 1 to 1000 operations is recorded based on accesses of about 1 to 1,000 times by the authorized user 30. Specifically, the whitelist database 34b is realized by a storage means such as a hard disk, a program that records information about an operation performed by the user 30 received by the communication means 34a in the storage means, a CPU (in the verification server 34) that executes the program and the like. As a result, in the whitelist database 34b, various types of information about operations performed by the authorized user 30 as shown in FIG. 2 are recorded. Information (record) on about 1 to 1000 accesses is stored for each user 30 in this record. For example, about 10 to 30 records for each person are preferable. While an example in which the latest 20 records for each person are stored will be described in this example, any number of records may be stored. In principle, the record is information about a series of operations from when the user 30 starts access to the website 10 until the user 30 logs off, and as described in FIG. 2, is data including information about a browser used and the like. However, operations performed by the user 30 may be stored as records. Records in the blacklist database 34c have a similar concept.

In the whitelist database 34b, information about an operation performed by the user 30 is compared to existing information for the corresponding user 30 in the whitelist database 34b, and when it is determined that “the operation does not correspond to the operation performed by the user 30” based on the fact that they are not similar to each other, this information is sent to the blacklist database 34c and stored in the blacklist database 34c. This determination is also executed by the above program. It may not necessarily compare a series of operations from access starts until access ends to determine whether it is similar or not. That is, only some information is compared, and it may be determined whether it is similar or not. That is, determination may be performed in real time during access by the user 30.

### Blacklist Database

The blacklist database 34c is a database in which information about an operation is recorded if information about the operation performed by the user 30 transmitted from the Web server 32a is not similar to the record in the whitelist database 34b and is so-called “different” information.

Specifically, the blacklist database 34c is realized by a storage means such as a hard disk, a program that records information about an operation sent to the blacklist database 34c in the storage means such as the hard disk when it is determined that (a program of) the whitelist database 34b is not similar to the record in the whitelist database 34b, a CPU (the verification server 34) that executes the program and the like.

As described above, in the whitelist database 34b of the verification server 34, information about an operation performed by the authorized user 30 is recorded. In the whitelist database 34b, information about an operation performed by the user 30 transmitted from the Web server 32a is compared with information in the whitelist database 34b, and when it is determined that they are not similar to each other but different information, information about the operation is transmitted to the blacklist database 34c. The blacklist database 34c is a database in which the transmitted information about an operation is stored.

In this manner, similarly to the whitelist database 34b, since the blacklist database 34c is a database in which information about an operation performed by the user 30 is recorded, its storage items are almost the same as in the whitelist database 34b, which is described in FIG. 2. However, in the blacklist database 34c, a unique flag “black confirmation flag” not included in the whitelist database 34b is provided for each record. This flag is a flag that is set to “1” when it is determined that information about each operation is information about an operation performed by a user who is not the authorized user 30.

An example in which the black confirmation flag is “1” corresponds to a preferable example in which a black confirmation flag is set in the scope of the claims.

When information about an operation “different” information about an operation in the whitelist database 34b is newly recorded in the blacklist database 34c, the black confirmation flag of information about the operation is “0.” An example in which the black confirmation flag is “0” is an example of a state in which the black confirmation flag is not set.

Then, when it is confirmed that information about the operation is not an operation performed by the authorized user 30 according to an additional authentication process performed by the Web server 32a, a black confirmation flag of a record of information about the operation is set to “1” (the black confirmation flag is set). An operation of setting the black confirmation flag to “1” and the like are executed by the above program. In addition, a value of the black confirmation flag is used for computation of a probability that is executed by the probability calculating means 34d.

### Probability Calculating Means

The probability calculating means 34d calculates a pretending probability which is a probability of information about an operation not being about one performed by an authorized user based on information about an operation performed by the user 30 transmitted from the Web server 32a, and transmits it to the authentication server 32b (corresponds to (5) in FIG. 3).

The probability calculating means 34d is realized by a program which describes a calculation operation that the probability calculating means 34d executes and a CPU of the verification server 34 that executes the program.

In addition, the probability calculating means 34d corresponds to a preferable example of a blacklist index calculating means in the scope of the claims. In addition, a pretending probability corresponds to a preferable example of “an index indicating that the user is not an authorized user” in the scope of the claims.

While the probability called a pretending probability has been calculated in this example, a simple index of “high” or “low” may be used as long as the index indicates a grade for the user not being an authorized user. In addition, the probability may be expressed as an integer of 0 to 10 or expressed in 11 levels. These also correspond to a preferable example of an index in the scope of the claims.

Based on whether information about an operation performed by the user 30 transmitted from the Web server 32a is similar to the record described in the blacklist database 34c, first, the probability calculating means 34d calculates a pretending probability according to the degree of similarity. As the degree of similarity is higher, the pretending probability is higher. As the degree of similarity is lower, the pretending probability is calculated to be lower. In this manner, various mathematical methods in which, according to a degree of similarity with a similar record, a probability corresponding to the record is calculated have been known in the related art, and thus such a computation method may be appropriately used. For convenience, a total value obtained by integrating square values of differences between various elements constituting the record (information about an operation) is calculated as a point, and a probability may be computed such that, as the point value is smaller, the probability is higher (approaches 1).

In addition, determination of similarity may be executed whenever information about an operation is transmitted. That is, comparison may be comparison of only some elements. For example, even if a page transition is performed about twice, comparison with the record (there may be a case in which many page transitions are recorded) in the blacklist database 34c may be performed. As a result, it is possible to calculate a pretending probability in real time according to an operation performed by the user 30.

In addition, when a black confirmation flag of a record (group) in the blacklist database 34c that is determined to be most similar to information about an operation performed by the user 30 transmitted from the Web server 32a is “1,” even with the same degree of similarity, compared to when a pretend confirmation flag is “0,” it is preferable to calculate and correct a required pretending probability to be higher. This is because it is thought that, if the black confirmation flag is similar to the record for which determination of whether the information is not about an operation performed by the authorized user 30 is confirmed, there is a high probability that the user is not the authorized user 30.

The probability calculating means 34d in this example calculates a pretending probability of the user 30 based on information in the blacklist database 34c in this manner.

When there is no record similar to information about an operation performed by the user 30 in the blacklist database 34c, in principle, a low pretending probability value is calculated and transmitted. When there is no record similar to information about an operation performed by the user 30 in the blacklist database 34c, the information may be compared with the record in the whitelist database 34b, and a pretending probability may be calculated based on the presence of a similar record and a level of similarity. In this example, when there is a record similar to information about the operation in the whitelist database 34b, a probability that the user is not the authorized user 30 (pretending probability) is calculated and corrected to be lower. On the other hand, when there is no record similar to information about the operation in the whitelist database 34b, a pretending probability may be calculated and corrected to be slightly higher. In this example, information about the operation that is a calculation target of a pretending probability is newly registered in the blacklist database 34c.

### 3. Operations

Next, a flow of operations of a system in this example will be described with reference to the drawings.

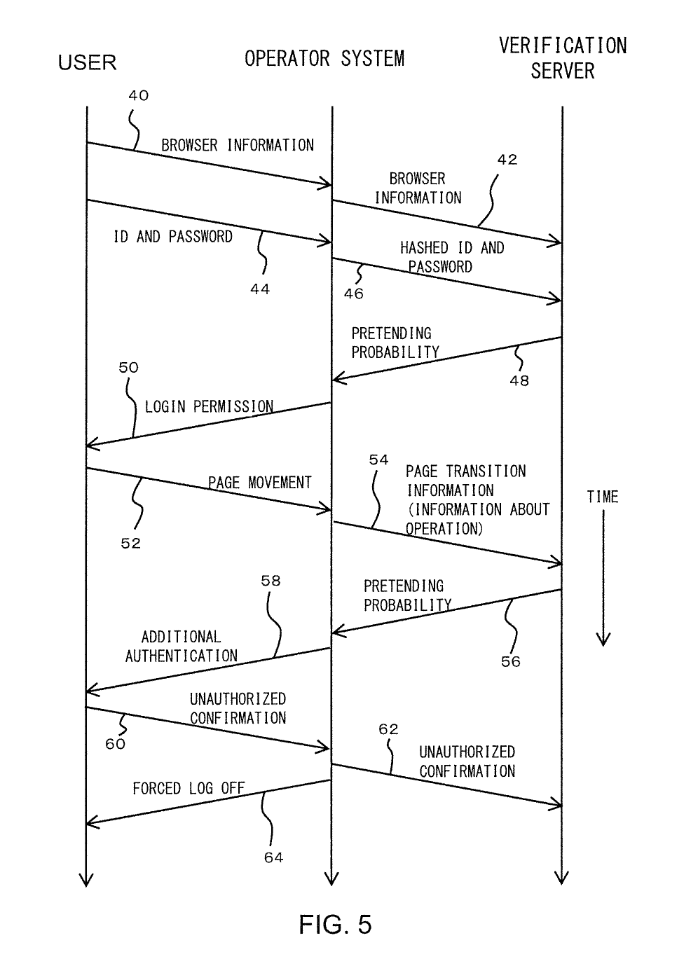

FIG. 5 is a time chart showing a flow of operations of the entire system shown in FIG. 3. In the time chart in FIG. 5, it is assumed that time elapses from the Top to the bottom.

First, the user 30 accesses the website 10. Then, information about a browser that is used for the user 30 to access is transmitted to the Web server 32a that provides the website 10. This operation is shown as transmission 40 of browser information in FIG. 5.

Next, the Web server 32a in the operator system 32 receives the transmitted browser information and transmits it to the verification server 34. This operation is shown as transmission 42 of browser information in FIG. 5. In the verification server 34, the communication means 34a receives the browser information and transmits the browser information to other components such as the whitelist database 34b.

Next, the user 30 transitions to the login page 14 and inputs an ID and a password. This is shown as ID and password transmission 44 in FIG. 5. Then, the Web server 32a receives the transmitted ID and password, and transmits it to the authentication server 32b for authentication ((2) in FIG. 3). The authentication server 32b performs authentication of the user 30 using the ID and password, hashes them, and transmits a hashed ID and a hashed password to the verification server 34.

This transmission operation is shown as hashed ID and password transmission 46 in FIG. 5. In the verification server 34, the communication means 34a receives the hashed ID and password information, and transmits the hashed ID and password to other components such as the whitelist database 34b. Thereby, in the whitelist database 34b, the blacklist database 34c, and the like, the hashed ID and password can be recorded.

While transmission 46 of the hashed ID and the hashed password (refer to FIG. 5) is executed by the authentication server 32b in this example, the Web server 32a may execute the transmission.

The verification server 34 obtains a “pretending probability” that the user 30 is not an authorized user from the transmitted hashed ID and password, and browser information, and transmits it to the authentication server 32b of the operator system 32. Calculation of a pretending probability is executed by the probability calculating means 34d, and transmission of a pretending probability is executed by the communication means 34a. This transmission is shown as transmission 48 of the pretending probability in FIG. 5.

The authentication server 32b receives the transmitted pretending probability. Then, it is determined whether additional authentication is executed for the user 30 based on the pretending probability. When the authentication server 32b does not decide execution of additional authentication, the fact that authentication has been successfully completed is transmitted to the Web server 32a ((6) in FIG. 3). The Web server 32a to which the fact that authentication is successful is transmitted transmits a login permission message to the user. This is shown as login permission 50 in FIG. 5.

Also, it is assumed that the authentication server 32b executes authentication based on an ID and a password that are not hashed (shown in (2) in FIG. 3), and authentication for an authorized user has been successfully completed. Of course, when authentication using this ID and password has failed, login is not permitted.

The logged in user 30 starts viewing of a desired page in the website 10 and appropriately moves between pages. This is shown as page movement 52 in FIG. 5. This page movement is transmitted to the Web server 32a, and the user 30 can move to a desired page. In addition, the Web server 32a transmits general information about an operation performed by a user including such a page movement to the verification server 34. This is shown as transmission 54 of page transition information in FIG. 5. Although it is described as transmission 54 of page transition information, it means general information about an operation performed by the user 30.

In the verification server 34, the page transition information (information about an operation performed by the user 30) is appropriately recorded in the whitelist database 34b. When information is not similar to the whitelist database 34b, it may be appropriately recorded in the blacklist database 34c. The page transition information (information about an operation performed by the user 30) is compared with records in the whitelist database 34b and the blacklist database 34c, and a level of similarity is obtained. A pretending probability which is a probability not being an authorized user is calculated based on the level of similarity.

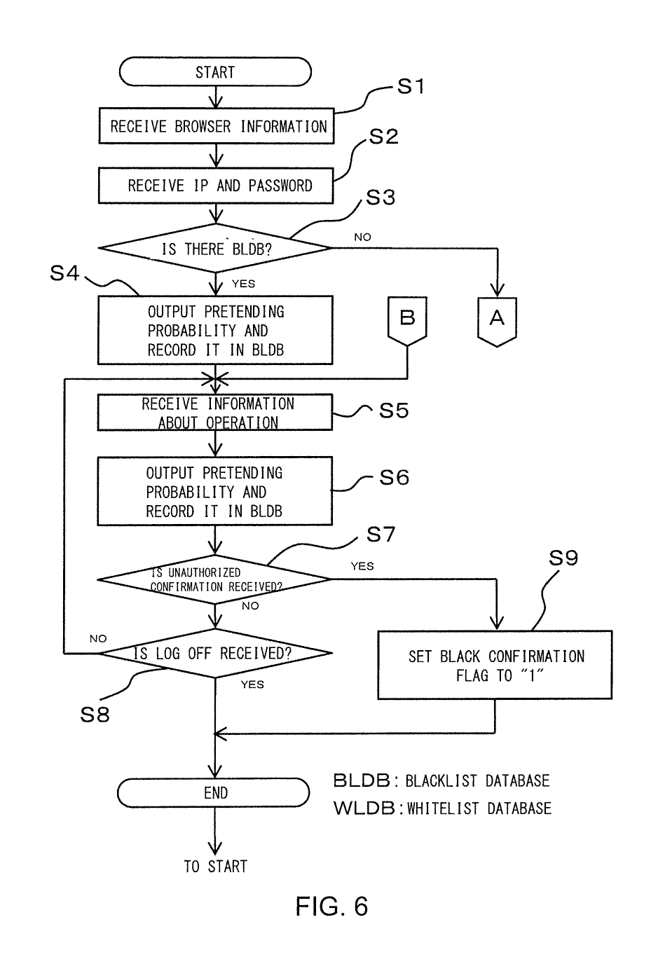

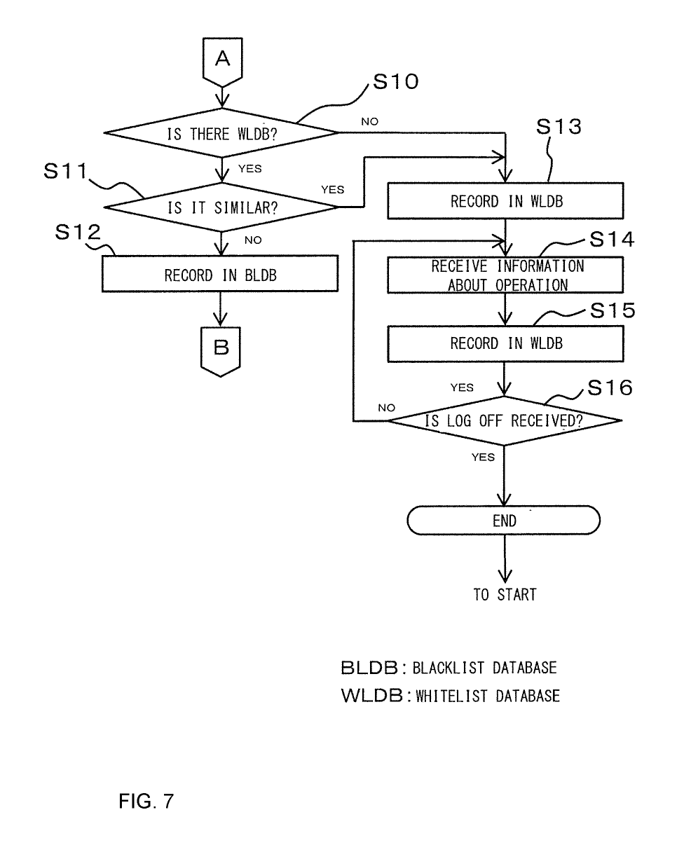

This calculation is executed by the probability calculating means 34d. A detailed calculation operation of a pretending probability and the like will be described with reference to a flowchart in FIG. 6 (and FIG. 7) below. The calculated pretending probability is transmitted to the authentication server 32b. This is shown as transmission 56 of the pretending probability in FIG. 5.

The authentication server 32b receives the transmitted pretending probability and determines whether additional authentication should be executed based on the probability. For example, this pretending probability is compared to a predetermined threshold value and when the pretending probability is smaller, execution of additional authentication may be determined. As a result of this determination, when the pretending probability is smaller than a predetermined threshold value and it is determined that additional authentication should be executed, the authentication server 32b transmits an instruction to execute additional authentication to the Web server 32a. The instruction of additional authentication is shown in (7) in FIG. 3. When the authentication server 32b determines that additional authentication is not executed, the authentication server 32b does not specifically issue (does not transmit) an instruction to the Web server 32a.

The Web server 32a that has received the instruction of additional authentication executes additional authentication for the user 30. This operation is shown as additional authentication 58 in FIG. 5. Additional authentication 58 can be executed in various manners. For example, for the user 30, it is preferable to ask an additional question that the user 30 can answer. In addition, it is preferable to transmit a predetermined email to a mobile terminal held by the user 30 and allow the user to input a code and a number in the email on a Web screen. In addition, it is also preferable to transmit an email to a mobile terminal held by the user 30 and send the message “if you are not currently accessing the website 10, please reply an email” and the like. In addition, various additional authentications 58 may be executed.

When such additional authentication 58 has failed (authentication process has not been completed normally), the Web server 32a transmits the fact that additional authentication has failed to the authentication server 32b. This transmission process is shown as unauthorized confirmation 60 in FIG. 5.

When the authentication server 32b has received unauthorized confirmation 60, it transmits the fact to the verification server 34. This is shown as unauthorized confirmation 62 in FIG. 5. In addition, the authentication server 32b transmits a forced log off instruction to the Web server 32a. This log off instruction is shown as forced log off 64 in FIG. 5. When the Web server 32a has received the forced log off 64, the user 30 forcibly logs off and the connection is released.

Also, a configuration in which an instruction of forced log off 64 is not issued may be used. In this example, a configuration in which, after the Web server 32a transmits unauthorized confirmation 60, even if there is no particular instruction from the outside, the user 30 logs off voluntarily may be used.

When the verification server 34 has received unauthorized confirmation 62, a black confirmation flag of a corresponding record in the internal blacklist database 34c is set to “1.” (the flag is set).

### When the User 30 is the Authorized User 30

Operation s when additional authentication 58 has failed, and it is confirmed that the user 30 is not an authorized user (unauthorized confirmation 60) have been described in FIG. 5. However, the user 30 may be an authorized user and may perform access using a different mobile terminal from a different place by chance. In this example, since the user 30 is an authorized user, additional authentication 58 is successful (authentication process is completed normally), and thus unauthorized confirmation 60 and unauthorized confirmation 62 in FIG. 5 are not transmitted. In this example, when the user 30 logs off and the Web server 32a receives the log off, the log off is transmitted to the verification server 34. When the verification server 34 receives the log off, it is determined that a series of operations ended, and information about operations performed by the user 30 before is recorded in the whitelist database 34b or the like as one record.

In principle, one record in the whitelist database 34b and the blacklist database 34c is information about operations for one session performed by the user 30 on the website 10, and is information about operations from when the user accesses, logs in, browses pages and logs off. However, one operation performed by the user 30 may be handled as one record.

As described above, according to the operations described with reference to the time chart in FIG. 5, it is possible to clearly certificate that the corresponding record of information about the operation in the blacklist database 34c is information about an operation performed by a user who is not an authorized user, and in the future, when information about an operation similar to information about an operation in the corresponding record is detected, a pretending probability can be calculated as high, and it is expected that access by a user who is not an authorized user can be more accurately recognized.

### Operation of the Verification Server 34

Next, operations of the verification server 34 will be described with reference to flowcharts in FIG. 6 and FIG. 7. In these flowcharts, in particular, an operation of constructing the whitelist database 34b and the blacklist database 34c and an operation of calculating a pretending probability will be mainly described, and other data transmission and reception and the like have already been described in FIGS. 3 and 5 and the like, and thus details thereof will not be described.

In addition, in FIG. 6, a BLDB represents a blacklist database, and a WLDB represents a whitelist database.

First, in Step S1, the communication means 34a of the verification server 34 receives information about a browser that the user 30 who has accessed uses. The received browser information is information that can be the content recorded of the whitelist database 34b and the like, and can be appropriately used in the whitelist database 34b, the blacklist database 34c and the like, and also is used to calculate a degree of similarity (level of similarity) with a record in an existing database in the probability calculating means 34d.

In Step S2, the communication means 34a of the verification server 34 receives a hashed ID and a hashed password. The received ID and password are output to other means in the verification server 34, and other means (the whitelist database 34b and the like) appropriately uses the (hashed) ID and password as necessary.

In Step S3, it is determined whether a record that is specified by the received ID and password and is a similar record exists in the blacklist database 34c. This determination is performed in the blacklist database 34c, and as a result, when there is a corresponding record, the process transitions to Step S4, and when a corresponding record does not exist in the blacklist database 34c, the process transitions to Step S10 in FIG. 7.

In Step S4, the probability calculating means 34d calculates a pretending probability based on the record in the blacklist database 34c which corresponds to the received ID and password and includes similar data. There may be one, two or more similar records. Then, a probability is calculated based on the following calculation criteria. Any calculation method may be used as long as it is based on the following criteria:

As a level of similarity for approximation is higher (more similar), a higher pretending probability is calculated.

As there are more similar records, a higher pretending probability is calculated.

When a black confirmation flag of a similar record is “1,” a pretending probability is calculated and corrected to be higher.

A pretending probability is calculated based on such calculation criteria. The probability calculating means 34d transmits the calculated pretending probability to the communication means 34a. The communication means 34a transmits the pretending probability to the authentication server 32b of the operator system 32 via a predetermined network.

In Step S4, along with transmission of the pretending probability, in the blacklist database 34c, the ID, the password, and a new record related to browser information are recorded.

In Step S5, the communication means 34a of the verification server 34 receive operation information of the user 30. The operation information is, for example, general information about an operation performed by the user 30 such as transmission 54 of page transition information in FIG. 5.

The communication means 34a outputs the received operation information to other means in the verification server 34, and other means (the whitelist database 34b and the like) appropriately uses the operation information as necessary.

In Step S6, the blacklist database 34c adds the operation information to the above new record created in Step S4. In addition, the probability calculating means 34d calculates a pretending probability including the received operation information. Then, the communication means 34a transmits the pretending probability to the authentication server 32b.

In this example based on an operation performed by the user 30, a pretending probability is calculated in real time in this manner and is provided to the authentication server 32b. As a result, based on the operation performed by the user 30, since information for making a determination of whether the user 30 is an authorized user (pretending probability) is quickly provided, the authentication server 32b can determine in real time whether additional authentication should be executed. As a result, it is possible to quickly block access by a user who is not an authorized user, and it is possible to prevent illegal actions more reliably.

In Step S7, it is determined whether the communication means 34a has received unauthorized confirmation (unauthorized confirmation 62 in FIG. 5). When the unauthorized confirmation is received, the process transitions to Step S9, and when the unauthorized confirmation is not received, the process transitions to Step S8.

In Step S8, the communication means 34a determines whether log off has received. This log off means that the user 30 executes an operation as usual, and it is not determined (is not confirmed) that the user is not an authorized user. As a result of this determination, when log off is received, information about operations performed by the user 30 before is recorded in the blacklist database 34c as one record. Recorded operation information (one record) is information about operations for one session for the website 10 of the user 30, and is information about operations from when the users accesses, logs in, browses pages, and logs off. The black confirmation flag of the record is set to “0.” In this manner, the verification server 34 ends operations for one session and waits for the user 30 to access again the website 10.

On the other hand, in Step S8, when the communication means 34a has not received log off, access on the website by the user 30 continues, and the process returns to Step S5 again, and a process of receiving information about an operation performed by the user 30 continues.

In Step S9, the verification server 34 receives unauthorized confirmation 62 (refer to FIG. 5), and the communication means 34a provides the unauthorized confirmation 62 to other means in the verification server 34. When the unauthorized confirmation 62 is received, it is determined that the fact that the user 30 is not the authorized user 30 is confirmed. Therefore, in the blacklist database 34c, a black confirmation flag of “1” is set for information (record) about an operation performed by the user in the blacklist database 34c. If this flag is set to “1,” again, when the user 30 that executes an operation similar to operation information of the user 30 appears, it is possible to calculate a high pretending probability for that user.

After Step S9, again, access by another user on the website 10 30 is awaited.

In Step S10 in FIG. 7, it is determined whether a record corresponding to the information about an operation performed by the user 30 is recorded in the whitelist database 34b. This determination is executed by the whitelist database 34b.

As a result of determination, when information about an operation performed by the user 30 is not recorded in the whitelist database 34b, and when information about an operation performed by the user 30 is recorded in the whitelist database 34b but the number of records of the user 30 is less than 20, it is determined that accumulation of information about operations related to the user 30 is insufficient, and the process transitions to Step S13. When the number of records is 20 or more, the process transitions to Step S11.

In the whitelist database 34b in this example, information about an operation performed by the user 30 is recorded, and the latest 20 data items are recorded as the record. When there are less than 20 data items, the process transitions to Step S13, and information about an operation performed by the user 30 is accumulated.

In Step S11, since there are 20 records corresponding to the user 30, information about an operation performed by the user 30 is compared with information about an operation in the whitelist database 34b, and determination of whether it is similar is executed. As a result, when information is similar to any record, to perform recording in the whitelist database 34b, the process transitions to Step S13.

In Step S12, since information about an operation performed by the user 30 is not similar to an existing record in the whitelist database 34b, it is determined as so-called “different” data, and recorded in the blacklist database 34c. This process is executed by the blacklist database 34c. Regarding this record, an initial value of the black confirmation flag is set to “0.”

An example in which information is not similar to an existing record in the whitelist database 34b corresponds to a preferable example of a case in which information “does not correspond” to a record in a whitelist database in the scope of claims.

In addition, an example in which access is performed several hundreds times in a day from the same IP address may be added to an example of “does not correspond” here. In addition, examples that “do not correspond” in the scope of the claims may include general cases in which access is estimated to be unauthorized.

A feature of this example is that the blacklist database 34c is provided and unauthorized access is determined more efficiently. To construct the blacklist database 34c, the whitelist database 34b is used, and when information about an operation is different from records therein, it is recorded in the blacklist database 34c. While the whitelist database 34b is mainly used in this example, information about an operation to be registered in the blacklist database 34c may be determined according to another method, that is, without using the whitelist database 34b. For example, an example in which access is performed repeatedly using the same ID in a short time or the like is determined to have a high possibility of being unauthorized access, and may be registered in the blacklist database 34c.

Since an operation after Step S12 is recording in the blacklist database 34c, the process transitions to Step S5 in FIG. 6. Operations after Step S5 are the same as those described above.

On the other hand, in Step S13 and subsequent processes, information about an operation performed by the user 30 is recorded in the whitelist database 34b. This recording operation is executed by the whitelist database 34b. In this example, the number of records of operation information (record) for a predetermined one user 30 is set to 20. For example, when there are less than 20 (records) of information about an operation performed by the user 30, new operation information is added and recorded directly. However, when 20 records of information about an operation performed by the user 30 (records) have already been recorded, new operation information is stored, and an old record is deleted. According to such an operation, only 20 records of information about the latest operation are always recorded in the whitelist database 34b.

In Step S14, the communication means 34a receives operation information. The communication means 34a provides the operation information to other means in the verification server 34.

In Step S15, in the whitelist database 34b, the provided operation information is recorded in the whitelist database 34b as information about an operation performed by the user 30.

When the provided operation information is recorded in the blacklist database 34c, a pretending probability is computed and transmitted to the authentication server 32b (Step S4 and the like).

However, as in Step S15, when the provided operation information is recorded in the whitelist database 34b, in principle, a pretending probability with a value of “0” is transmitted to the authentication server 32b. That is, an example in which the provided operation information is recorded in the whitelist database 34b is an example in which information about an operation performed by the user 30 is similar to operation information considered to be related to that performed by the authorized user 30 in the whitelist database 34b, and a pretending probability is reasonably thought to be “0.”

However, as in Step 15, even if the provided operation information is recorded in the whitelist database 34b, since a level of similarity with an existing record in the whitelist database 34b is computed, a pretending probability may be calculated based on the level of similarity.

In Step S16, the communication means 34a determines whether log off is received. This determination is executed by the communication means 34a. As a result of determination, when log off is received, information about operations performed by the user 30 before is recorded in the whitelist database 34b. Then, access by another user 30 on the website 10 is awaited.

On the other hand, in Step S16, when log off is not received, the process transitions to Step S14, and an operation of receiving information about an operation performed by the user 30 continues.

As described above, the verification server 34 transmits and receives data to and from the operator system 32, and constructs the internal whitelist database 34b and blacklist database 34. In addition, in the verification server 34, the probability calculating means 34d therein calculates a pretending probability based on, in principle, the blacklist database 34c, and transmits it to the authentication server 32b.

In addition, while an example in which there is one operator system 32 has been described herein, there may be a plurality of operator systems 32. In this example, the plurality of operator systems 32 can share the verification server 34.

### Effects

According to the above operations, in this example, not only the whitelist database 34b, but also the blacklist database 34c in which information about an operation performed by the user 30 who may not be the authorized user 30 is recorded can be constructed.

In addition, when the verification server 34 is shared and used in the plurality of operator systems 32, it is possible to share the blacklist database 34c. As a result, information that is recorded in the blacklist database 34c, which is not information about an operation performed by the authorized user 30, in the website 10 for a certain operator, can be used by other operators, and can increase a possibility of preventing unauthorized access by a malicious third party in advance.

In particular, in recent years, there are many cases in which unauthorized access is performed consecutively on a plurality of websites using a set of an ID and a password obtained by a malicious third party. In response to such consecutive unauthorized access, the verification server 34 in this example can be a particularly useful countermeasure. In addition, in this example, since not only a simple ID of the user 30, but also the blacklist database 34c and the whitelist database 34b in which information about an operation performed by the user 30 is recorded are constructed, it is possible to detect access by a malicious third party more efficiently. In addition, it is expected that, since operation information is recorded, it is possible to obtain a pretending probability in real time for each operation performed by the user 30, and it is possible to detect access by a malicious third party more quickly.

### 4. Modified Examples

(1) In the above-described example, the probability calculating means 34d calculates a probability of the user not being an authorized user. This probability value is a real number value of 0 to 1. However, it is preferable to use an index indicating a grade for the user not being an authorized user instead of the “probability.” The probability is a preferable example of the index, but other indexes may be used. For example, as such an index, a level of similarity with data in the blacklist database 34c may be used. In this example, it is thought that, as the degree of similarity is higher, the user is highly likely to not be an authorized user. Thus, such a level of similarity is preferably used as an index. In addition, any index may be calculated and used as long as it indicates a grade for the user not being an authorized user.
(2) An example in which the verification server 34 is located apart from the Web server 32a has been described in the above-described example. However, the verification server 34 may be located at any place in which it can be connected from the Web server 32a and the authentication server 32b, and may be disposed at the same location as the Web server 32a and, for example, may be located in the operator system 32.

In addition, an example in which the authentication server 32b is located at the same site as the Web server 32a has been described in the above-described example. However, the authentication server 32b may be located at any place in which it can be connected from the Web server 32a and the verification server 34, and may be disposed at a location apart from the Web server 32a and, for example, may be located outside the operator system 32.

(3) In the above-described example, the number of records of information (record) about operations performed by the same user in the whitelist database 34b is set to, for example, 20, but the number may be smaller than or more than 20. In addition, a configuration in which the number of registrations is dynamically adjusted according to situations may be used.
(4) In the above-described example, the verification server 34 transmits a pretending probability to the operator system 32. However, a configuration in which most similar information in the blacklist database 34c which is a main factor in computation of a pretending probability is transmitted along with the pretending probability may be used.

In such a configuration, on the side of the operator system 32, it is possible to know what type of unauthorized access is performed, and contribute to ensuring security in some examples. However, depending on the country, unauthorized access data may be a personal information protection subject or other protection subject. In such an example, corresponding information should be carefully provided.

(5) In the above-described example, when information about an operation performed by the user 30 is recorded in the whitelist database 34b, “0” is transmitted as a pretending probability. However, a pretending probability is calculated according to a level of similarity with a record in the whitelist database 34b, a pretending probability with a value other than “0” may be transmitted.
(6) In the above-described example, the number of records in the blacklist database 34c is not limited. However, in consideration of a calculation speed and the like of comparison and verification, the number may be limited. For example, a process such as deleting from the old record may be performed.
(7) In the above-described example, data in the whitelist database 34b is recorded based on actual access, but typical authorized data may be recorded in advance artificially. In addition, in the blacklist database 34c, an unauthorized access example known in advance may be artificially stored.
(8) In the above-described example, data in the whitelist database 34b is updated whenever access is newly performed, and old data is deleted, but a fixed record may be artificially designated. This is considered for users having a low access frequency.
(9) In addition, records in the whitelist database 34b and the blacklist database 34c may be appropriately tuned by artificial means, or other means, and also records that are not very important may be deleted by manually. Various artificial operations may be performed.
(10) In the above example, a hashed ID and a hashed password are recorded in the whitelist database 34b and the blacklist database 34c, but un-hashed data may be used and an ID and password on which predetermined encryption is performed may be used.

While the example has been described above in detail, various function means are realized by a program, a CPU that executes the program and the like. The various programs described above correspond to a preferred example of a computer program in the scope of the claims.

In addition, while the example has been described above in detail, it only shows a specific example of performing our method. The technical scope of this disclosure is not limited to the example. Our systems, devices, methods and programs can be variously modified within the scope without departing from the spirit and these are also included in the technical scope of this disclosure.

1-13. (canceled)

14. A service provision system that provides a predetermined service to a user, comprising:
a server unit configured to provide a predetermined service to the user; and
an authentication server unit configured to determine whether the user is an authorized user,
wherein the server unit includes
a service provision means that provides information about the user to the authentication server unit and executes provision of the predetermined service to the user who is determined as an authorized user by the authentication server unit, and
a transmission means that transmits information about an operation performed by the user on the server unit to an external verification device,
wherein the authentication server unit includes
a determination means that receives information about the user from the server unit and determines whether the user is an authorized user, and
a reception means that receives an index indicating that the user is not an authorized user from the external verification device, and
is able to acquire the index that the user is not an authorized user.

15. The service provision system according to claim 14,
wherein the authentication server unit further includes
a confirmation instruction means that, when it is determined that a probability of the user not being an authorized user is a predetermined threshold value or more based on the index received by the reception means, issues an instruction to execute a confirmation process of confirming whether the user is an authorized user to the server unit, and
wherein, when the instruction to execute the confirmation process is received, the service provision means of the server unit executes the confirmation process for the user.

16. The service provision system according to claim 14, wherein, when a result of the confirmation process performed by the service provision means is that it is determined that the user is not an authorized user, the transmission means transmits information indicating that the user is not an authorized user to the external verification device.

17. A verification device configured to obtain, based on information about an operation performed by a user, an index indicating that the user is not an authorized user, comprising:
a communication means that receives information about an operation performed by a user from an external service provision system;
a blacklist database in which information about an operation performed by a user who is determined as not being an authorized user is recorded; and
a blacklist index calculating means that compares information about an operation performed by the user received by a reception means to data in the blacklist database, and calculates an index indicating that the user is not an authorized user from its degree of similarity and transmits the index.

18. The verification device according to claim '7, wherein the communication means transmits the index indicating that the user is not an authorized user to the outside.

19. The verification device according to claim 17, wherein the index indicating that the user is not authorized is a probability of the user not being an authorized user.

20. The verification device according to claim 17,
wherein, in a whitelist database in which information about an operation performed by the authorized user is recorded,
when it is determined that the information about an operation performed by the user received by the reception means does not correspond to a record in the whitelist database, in the blacklist database, the information about an operation performed by the user received is registered in the blacklist database.

21. The verification device according to claim 17, wherein, when the reception means has received the information indicating that the user is not an authorized user, in the blacklist database, a black confirmation flag is set for information about an operation performed by the user in the blacklist database.

22. The verification device according to claim 21, wherein the blacklist index calculating means compares the information about an operation performed by the user received by the reception tos with a record in the blacklist database, and when the black confirmation flag of a record in the blacklist database having a high degree of similarity is set, calculates an index indicating that the user is not an authorized user to be higher and transmits the index.

23. A service provision method of providing a predetermined service to a user using a service provision system that includes a server unit configured to provide a predetermined service to the user and an authentication server unit configured to determine whether the user is an authorized user, the method comprising:
a service provision step in which the server unit provides information about the user to the authentication server unit, and when the authentication server unit determines that the user is an authorized user, provision of the predetermined service to the user is executed;
a transmission step in which the server unit transmits information about an operation performed by the user on the server unit to an external verification device;
a determination step in which the authentication server unit receives information about the user from the server unit and it is determined whether the user is an authorized user; and
a reception step in which the authentication server unit receives an index indicating that the user is not an authorized user from the external verification device.

24. A verification method of obtaining, based on information about an operation performed by a user, an index indicating that the user is not an authorized user, comprising:
a communication step in which information about an operation performed by the user is received;
a step in which information about an operation performed by the user who is determined as not being an authorized user is recorded in a blacklist database; and
a blacklist index calculation step in which information about an operation performed by the user received in the communication step is compared with data in the blacklist database, and an index indicating that the user is not an authorized user is calculated from its degree of similarity and transmitted.

25. A computer program causing a computer to operate as a service provision system that includes a server unit configured to provide a predetermined service to a user and an authentication server unit configured to determine whether the user is an authorized user, the computer program causing the computer to execute:
a service provision procedure in which the server unit provides information about the user to the authentication server unit, and when the authentication server unit determines that the user is an authorized user, provision of the predetermined service to the user is executed;
a transmission procedure in which the server unit transmits information about an operation performed by the user on the server unit to an external verification device;
a determination procedure in which the authentication server unit receives information about the user from the server unit and it is determined whether the user is an authorized user; and
a reception procedure in which the authentication server unit receives an index indicating that the user is not an authorized user from the external verification device.

26. A computer program causing a computer to operate as a verification device configured to obtain, based on information about an operation performed by a user, an index indicating that the user is not an authorized user, the computer program causing the computer to execute:
a communication procedure in which information about an operation performed by the user is received;
a procedure in which information about an operation performed by the user who is determined as not being an authorized user is recorded in a blacklist database; and
a blacklist index calculation procedure in which information about an operation performed by the user received in the communication procedure is compared with data in the blacklist database, and an index indicating that the user is not an authorized user is calculated from its degree of similarity and transmitted.
